(19) United States
(12) Patent Application Publication
(10) Pub. No.: US 2002/0077079 A1
(43) Pub. Date: Jun. 20, 2002

(54) Mobile terminal and operation lock setting method for same enabling easy use of operation lock function

(76) Inventor: Tatsuo Ishihara, Tokyo (JP)

Correspondence Address: YOUNG & THOMPSON, 745 SOUTH 23RD STREET 2ND FLOOR, ARLINGTON, VA, 22202

(21) Appl. No.: 09/984,602

(22) Filed: Oct. 30, 2001

(30) Foreign Application Priority Data
Oct. 30, 2000 (JP) 2000-334944
Oct. 15, 2001 (JP) 2001-317375

(51) Int. Cl. H04M 1/66

(52) U.S. Cl. 455/410; 455/564; 455/573

(57) ABSTRACT

In a mobile terminal such as a portable cellular phone that is provided with a dial lock function (operation lock function), the state of the mobile terminal is turned from a dial locked state to a dial unlocked state (state transition 3) if a specific secret number is inputted to the mobile terminal (factor 4), and the state of the mobile terminal is turned from the operation unlocked state to the operation locked state (state transitions 11, 7, 9) if at least one of a folded state of the mobile terminal (factor 12), external device connection to the mobile terminal (factor 8), and a battery charging state of the mobile terminal (factor 10) is detected by the mobile terminal. The user of the mobile terminal is allowed to use the dial lock function (operation lock function) more easily and thereby third party's illegal use of the mobile terminal is prevented more efficiently.

### BACKGROUND OF THE INVENTION

The present invention relates to a mobile terminal such as a portable cellular phone that is provided with a dial lock function, and in particular, to a mobile terminal in which setting/releasing of the dial lock can be done easily.

### DESCRIPTION OF THE RELATED ART

Many of the mobile terminals such as portable cellular phones used today are provided with the so-called “dial lock function” for preventing call origination by a third party in cases where the mobile terminal is stolen, lost, etc. In the following, the dial lock function will be explained referring to FIG. 1.

FIG. 1 is a schematic diagram for explaining a dial lock function which is generally employed in conventional portable cellular phones. When a specific secret number is inputted to the portable cellular phone (factor 65), the state of the portable cellular phone turns from a dial locked state 61 to a dial unlocked state 62 (state transition 63). When a dial lock setting operation is performed by the user (factor 66), the state turns from the dial unlocked state 62 to the dial locked state 61 (state transition 64).

The portable cellular phone can be turned into the dial locked state 61 by performing the dial lock setting operation (factor 66), thereby the illegal use of the portable cellular phone by a third party (not knowing the specific secret number) can be prevented.

On the other hand, a user who knows or memorized the specific secret number is allowed to use the portable cellular phone by inputting the secret number (factor 65) and thereby causing the state transition 63 from the dial locked state 61 to the dial unlocked state 62.

As described above, even if a mobile terminal (such as a portable cellular phone) having the dial lock function is stolen, lost, etc., the possibility of illegal use by a third party is very low.

However, if the user wanted to originate a call when the mobile terminal is in the dial locked state 61, the user is required to release the dial lock by performing a predetermined operation (input of a secret number etc.) before dialing a phone number for the call origination. After the call is over, the user has to set the dial lock again by performing the dial lock setting operation since the dial lock has been released.

As above, the setting and releasing of the dial lock in the conventional mobile terminals are complicated and troublesome. However, the prevention of illegal use by a third party in cases of loss or theft becomes impossible if the user neglected the dial lock setting operation at each end of use. It has been pointed out that users easily forget to perform the dial lock setting operation or ignore (do not use) the dial lock function because of the troublesome dial lock setting operations.

In order to resolve the above problems, a new type of dial lock function has been disclosed in Japanese Patent Application Laid-Open No.HEI10-257170 (hereafter, referred to as “the first prior art”). In the technique of the first prior art, the dial locked state 61 is released when a specific secret number and a phone number of a called party are inputted. When the conversation with the called party is ended, the state of the mobile terminal (portable cellular phone) is automatically returned to the dial locked state 61.

A mobile terminal having another dial lock function for preventing illegal dialing operation has been disclosed in Japanese Patent Application Laid-Open No.HEI11-355432 (hereafter, referred to as “the second prior art”). In the dial lock function of the second prior art, a secret number inputted by the user is verified when a first selection key for releasing the dial lock or a second selection key for temporarily releasing the dial lock is pushed by the user. If the inputted secret number is correct, the dial lock is released according to the “release” or “temporary release” which has been designated by the user.

In the aforementioned first prior art, the user is required to input the secret number every time he/she makes a call, and thus the dial lock releasing operation becomes tiresome to the user and the usability of the mobile terminal is impaired. Especially when the user has to make two or more calls successively, the labor for inputting the secret number on each call becomes terribly heavy for the user.

The second prior art involves the following problems or drawbacks. First, the user has to determine beforehand whether to release the dial lock function or to temporarily release the dial lock function. However, there are cases where the user sets the dial lock just after a call although the user has selected “release” of the dial lock function. On the other hand, there are cases where the user happens to want to maintain the dial unlocked state 62 just after a call although the user has selected “temporary release” of the dial lock function.

Second, the dial lock releasing operation in the second prior art is more complicated than that of ordinary mobile terminals since the selection between “release” and “temporary release” has to be inputted in addition to the input of the specific secret number.

Third, the second prior art does not specify the details of the dial lock setting operation, therefore, the user is required to carry out a complicated procedure for the dial lock setting as before.

Fourth, the task of looking for the first selection key (for release) or the second selection key (for temporarily release) in the mobile terminal of a limited size and pushing the selection key becomes very troublesome for the user.

### SUMMARY OF THE INVENTION

It is therefore the primary object of the present invention to provide a mobile terminal to which the setting/releasing of the dial lock or operation can be done easily.

Another object of the present invention is to provide an operation lock setting method by which setting/releasing of the dial lock or operation of a mobile terminal can be done easily.

In accordance with a first aspect of the present invention, there is provided a mobile terminal having an operation lock function, in which the state of the mobile terminal is turned from an operation locked state to an operation unlocked state if a specific secret number is inputted to the mobile terminal, and the state of the mobile terminal is turned from the operation unlocked state to the operation locked state if a folded state of the mobile terminal is detected by the mobile terminal.

In accordance with a second aspect of the present invention, in the first aspect, the state of the mobile terminal is turned from the operation unlocked state to the operation locked state if a lock setting operation is performed by a user.

In accordance with a third aspect of the present invention, there is provided a mobile terminal having an operation lock function, in which the state of the mobile terminal is turned from an operation locked state to an operation unlocked state if a specific secret number is inputted to the mobile terminal, and the state of the mobile terminal is turned from the operation unlocked state to the operation locked state if external device connection to the mobile terminal is detected by the mobile terminal.

In accordance with a fourth aspect of the present invention, in the third aspect, the state of the mobile terminal is turned from the operation unlocked state to the operation locked state if a lock setting operation is performed by a user.

In accordance with a fifth aspect of the present invention, there is provided a mobile terminal having an operation lock function, in which the state of the mobile terminal is turned from an operation locked state to an operation unlocked state if a specific secret number is inputted to the mobile terminal, and the state of the mobile terminal is turned from the operation unlocked state to the operation locked state if a battery charging state of the mobile terminal is detected by the mobile terminal.

In accordance with a sixth aspect of the present invention, in the fifth aspect, the state of the mobile terminal is turned from the operation unlocked state to the operation locked state if a lock setting operation is performed by a user.

In accordance with a seventh aspect of the present invention, there is provided a mobile terminal having an operation lock function, in which the state of the mobile terminal is turned from an operation locked state to an operation unlocked state if a specific secret number is inputted to the mobile terminal, and the state of the mobile terminal is turned from the operation unlocked state to the operation locked state if at least one of a folded state of the mobile terminal and external device connection to the mobile terminal is detected by the mobile terminal.

In accordance with an eighth aspect of the present invention, in the seventh aspect, the state of the mobile terminal is turned from the operation unlocked state to the operation locked state if a lock setting operation is performed by a user.

In accordance with a ninth aspect of the present invention, there is provided a mobile terminal having an operation lock function, in which the state of the mobile terminal is turned from an operation locked state to an operation unlocked state if a specific secret number is inputted to the mobile terminal, and the state of the mobile terminal is turned from the operation unlocked state to the operation locked state if at least one of a folded state and a battery charging state of the mobile terminal is detected by the mobile terminal.

In accordance with a tenth aspect of the present invention, in the ninth aspect, the state of the mobile terminal is turned from the operation unlocked state to the operation locked state if a lock setting operation is performed by a user.

In accordance with an eleventh aspect of the present invention, there is provided a mobile terminal having an operation lock function, in which the state of the mobile terminal is turned from an operation locked state to an operation unlocked state if a specific secret number is inputted to the mobile terminal, and the state of the mobile terminal is turned from the operation unlocked state to the operation locked state if at least one of external device connection to the mobile terminal and a battery charging state of the mobile terminal is detected by the mobile terminal.

In accordance with a twelfth aspect of the present invention, in the eleventh aspect, the state of the mobile terminal is turned from the operation unlocked state to the operation locked state if a lock setting operation is performed by a user.

In accordance with a thirteenth aspect of the present invention, there is provided a mobile terminal having an operation lock function, in which the state of the mobile terminal is turned from an operation locked state to an operation unlocked state if a specific secret number is inputted to the mobile terminal, and the state of the mobile terminal is turned from the operation unlocked state to the operation locked state if at least one of a folded state of the mobile terminal, external device connection to the mobile terminal, and a battery charging state of the mobile terminal is detected by the mobile terminal.

In accordance with a fourteenth aspect of the present invention, in the thirteenth aspect, the state of the mobile terminal is turned from the operation unlocked state to the operation locked state if a lock setting operation is performed by a user.

In accordance with a fifteenth aspect of the present invention, there is provided a mobile terminal having an operation lock function. The mobile terminal comprises a folded/unfolded state detection means and an operation lock setting means. The folded/unfolded state detection means detects whether the mobile terminal is in a folded state or in an unfolded state. The operation lock setting means sets the operation lock of the mobile terminal according to detection of a state transition from the unfolded state to the folded state by the folded/unfolded state detection means.

In accordance with a sixteenth aspect of the present invention, in the fifteenth aspect, the mobile terminal further comprises an operation lock setting timer which is started when the state transition from the unfolded state to the folded state is detected by the folded/unfolded state detection means. The operation lock setting timer is stopped when a state transition from the folded state to the unfolded state is detected by the folded/unfolded state detection means. The operation lock setting means sets the operation lock if the operation lock setting timer counted a preset time-out period.

In accordance with a seventeenth aspect of the present invention, in the sixteenth aspect, the mobile terminal further comprises a timer setting means for letting a user set on/off and the time-out period of the operation lock setting timer.

In accordance with an eighteenth aspect of the present invention, there is provided an operation lock setting method for a mobile terminal having an operation lock function. In the operation lock setting method, the state of the mobile terminal is turned from an operation locked state to an operation unlocked state if a specific secret number is inputted to the mobile terminal, and the state of the mobile terminal is turned from the operation unlocked state to the operation locked state if at least one of a folded state of the mobile terminal, external device connection to the mobile terminal, and a battery charging state of the mobile terminal is detected by the mobile terminal.

In accordance with a nineteenth aspect of the present invention, in the eighteenth aspect, the state of the mobile terminal is turned from the operation unlocked state to the operation locked state if a lock setting operation is performed by a user.

In accordance with a twentieth aspect of the present invention, there is provided an operation lock setting method for a mobile terminal having an operation lock function. The operation lock setting method comprises a folded/unfolded state detection step and an operation lock setting step. In the folded/unfolded state detection step, whether the mobile terminal is in a folded state or in an unfolded state is detected. In the operation lock setting step, the operation lock of the mobile terminal is set according to detection of a state transition from the unfolded state to the folded state by the folded/unfolded state detection step.

In accordance with a twenty-first aspect of the present invention, in the twentieth aspect, the operation lock setting step includes an operation lock setting timer starting step, an operation lock setting timer stopping step and a time-out step. In the operation lock setting timer starting step, an operation lock setting timer is started when the state transition from the unfolded state to the folded state is detected by the folded/unfolded state detection step. In the operation lock setting timer stopping step, the operation lock setting timer is stopped when a state transition from the folded state to the unfolded state is detected by the folded/unfolded state detection step. In the time-out step, the operation lock is set if the operation lock setting timer counted a preset time-out period.

In accordance with a twenty-second aspect of the present invention, in the twenty-first aspect, the operation lock setting method further comprises a timer setting step. In the timer setting step, a user sets on/off and the time-out period of the operation lock setting timer.

### BRIEF DESCRIPTION OF THE DRAWINGS

The objects and features of the present invention will become more apparent from the consideration of the following detailed description taken in conjunction with the accompanying drawings, in which:

FIG. 1 is a schematic diagram for explaining a dial lock function which is generally employed in conventional mobile terminals;

FIG. 2 is a block diagram showing an example of functional blocks of a mobile terminal in accordance with a first embodiment of the present invention;

FIG. 3 is an external view showing a folding portable cellular phone as an example of the mobile terminal of the first embodiment of the present invention;

FIG. 4 is a flow chart explaining the operation of a control section of the mobile terminal of the first embodiment;

FIG. 5 is a flow chart explaining a reception process which is executed as one of interrupts in the mobile terminal of the first embodiment;

FIG. 6 is a schematic diagram explaining the dial lock setting/releasing operations of the mobile terminal of the first embodiment;

FIG. 7 is a flow chart explaining an example of a judgment process in which the control section judges whether the dial lock should be set or not;

FIG. 8 is a schematic diagram explaining dial lock setting/releasing operations of a mobile terminal in accordance with a second embodiment of the present invention;

FIG. 9 is a flow chart explaining the operation of a control section of the mobile terminal of the second embodiment;

FIG. 10 is a flow chart explaining a reception process which is executed as one of interrupts in the mobile terminal of the second embodiment;

FIG. 11 is a flow chart explaining an interrupt which is executed in the mobile terminal of the second embodiment when a folded state or an unfolded state is detected; and

FIG. 12 is a flow chart explaining a timer interrupt process which is executed in the mobile terminal of the second embodiment.

### DESCRIPTION OF THE PREFERRED EMBODIMENTS

Referring now to the drawings, a description will be given in detail of preferred embodiments in accordance with the present invention.

Embodiment 1

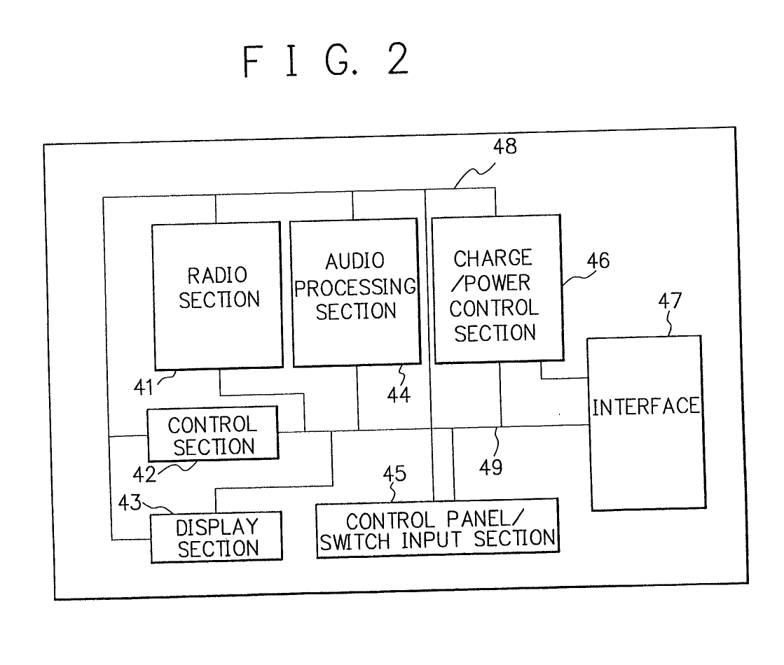

FIG. 2 is a block diagram showing an example of functional blocks of a mobile terminal in accordance with a first embodiment of the present invention. The mobile terminal shown in FIG. 2 includes a radio section 41, a control section 42, a display section 43, an audio processing section 44, a control panel/switch input section 45, a charge/power control section 46, an interface 47, power supply lines 48, and a control bus 49.

The radio section 41 conducts processing concerning radio communication. The control section 42 is connected to other blocks via the control bus 49 and controls the operation of the whole mobile terminal. The display section 43 presents necessary information (functional status, the presence or absence of incoming calls, etc.) to the user by displaying the information on a display etc. Incidentally, the display section 43 can be omitted if displaying information is unnecessary. The audio processing section 44 converts voice into audio signals and vice versa. The audio processing section 44 also makes corrections to the audio signals. The control panel/switch input section 45 receives control instructions (operation inputs) from the user. The control instructions inputted by the user and received by the control panel/switch input section 45 are supplied to the control section 42 as control signals. The charge/power control section 46 manages the power supply to the blocks of the mobile terminal by use of the power supply lines 48. When the charge/power control section 46 is connectable to a charger via the interface 47, a battery of the mobile terminal is charged. The interface 47 is a functional block for the connection of the mobile terminal to external devices. In the case where a charger is connected as the external device, the interface 47 provides connection between the charger and the charge/power control section 46.

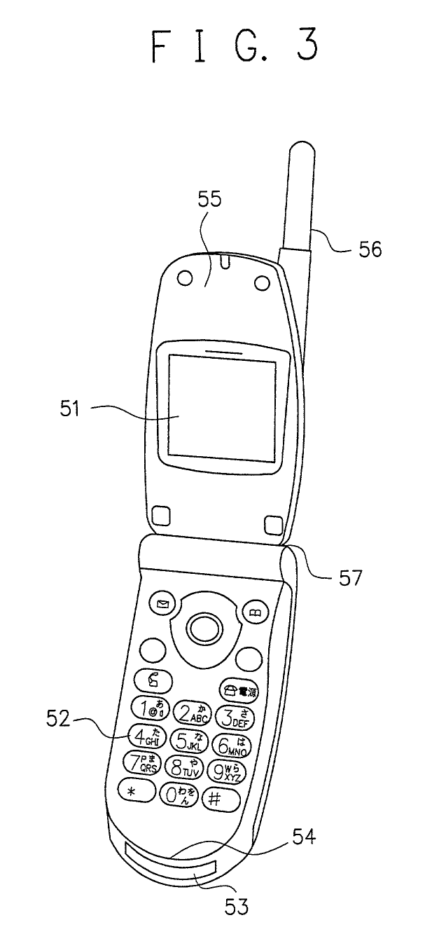

FIG. 3 is an external view showing a folding portable cellular phone as an example of the mobile terminal of the first embodiment of the present invention. The folding portable cellular phone of FIG. 3 is provided with a display 51 (LCD, for example), a control panel 52, an interface connector 53, a fold-detection magnet 54 (unshown), a reed switch 55 (unshown), an antenna 56 and a hinge 57.

Incidentally, the mobile terminal or portable cellular phone of this embodiment is not limited to the example of FIG. 3 nor required to be foldable. In the case where the mobile terminal is not foldable, the fold-detection magnet 54, the reed switch 55 and the hinge 57 are omitted.

The display 51, which is implemented by an LCD (liquid crystal display) for example, is controlled by the display section 43 and thereby displays necessary information (functional status, the presence or absence of incoming calls, etc.) to the user. The control panel 52, which is under the control of the control panel/switch input section 45, receives control instructions (operation inputs) from the user. The control panel/switch input section 45 sends the received control instructions to the control section 42 as control signals. The interface connector 53, which is connectable to external devices directly or indirectly, communicates data (telephone directory data, e-mail data, etc.) with the external devices. As mentioned before, it is also possible to let the interface connector 53 function as a charging terminal. In such a case, the interface connector 53 provides connection between a charger and the charge/power control section 46 for charging the battery of the mobile terminal. The charging terminal can also be placed on the back or the bottom of the mobile terminal so that the charging can easily be done by putting the mobile terminal on a charging holder. The reed switch 55 judges whether or not the fold-detection magnet 54 is within a predetermined distance from itself by detecting magnetic force and thereby judges whether the mobile terminal (folding portable cellular phone) is folded or not. The result of the judgment is supplied to the control section 42. The hinge 57, which connects the upper part and lower part of the mobile terminal, makes the folding possible.

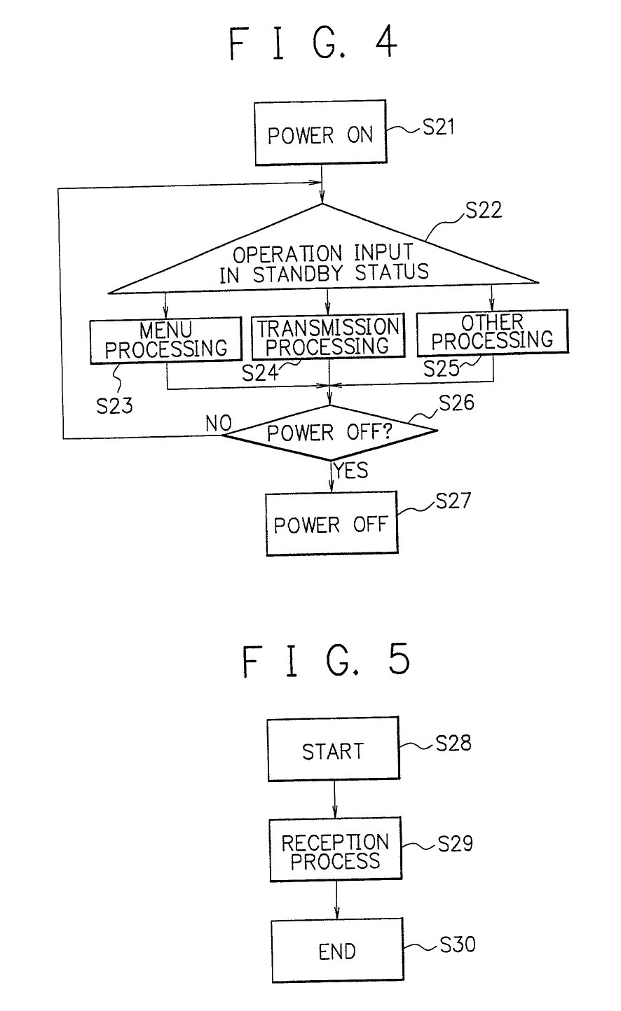

FIG. 4 is a flow chart explaining the operation of the control section 42 of the mobile terminal of the first embodiment. When the power of the mobile terminal is turned on (step S21), the mobile terminal in a standby status waits for an operation input by the user (step S22). The operation input by the user is generally done by use of the control panel 52, however, other elements can also be used for the operation input. For example, detection of unfolding of the mobile terminal by the reed switch 55 can also be used as the operation input.

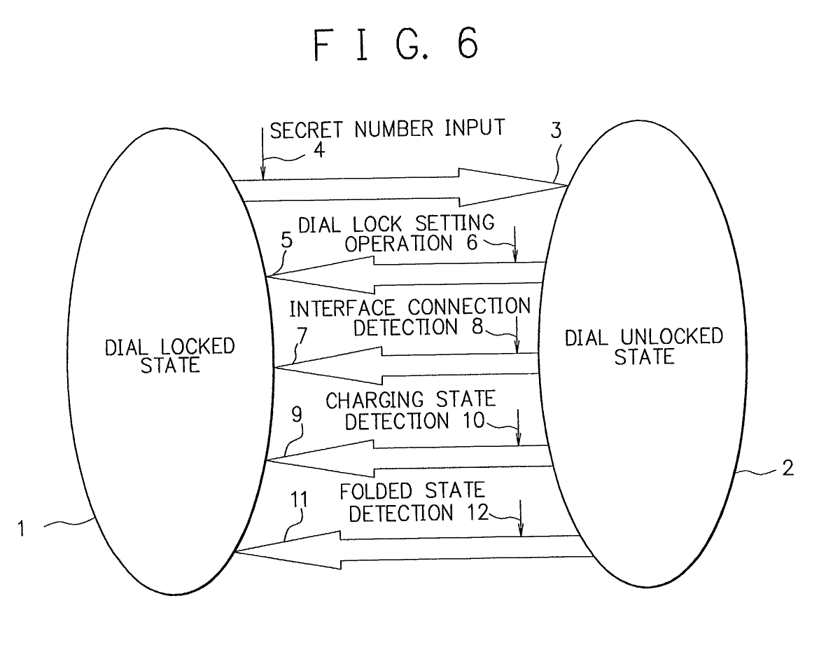

Depending on the type of the operation input, the process of FIG. 4 proceeds to a step S23 (menu processing), a step S24 (transmission processing) or a step S25 (other processing). The menu processing of the step S23 is executed when a menu key of the control panel 52 is pushed by the user. The menu processing includes a dial lock setting operation 6 which is shown in FIG. 6. The “other processing” of the step S25 means processing other than the menu processing (step S23) and the transmission processing (step S24). The “other processing” includes a dial lock releasing operation 3 of FIG. 6 which is executed when a specific secret number is inputted (factor 4). A detailed explanation of the dial lock setting/releasing operations will be given later. The control section 42 repeats the above process until the power of the mobile terminal is turned off (“YES” in step S26).

FIG. 5 is a flow chart explaining a reception process which is executed as one of interrupts in the mobile terminal of the first embodiment. Each interrupt is handled with higher priority than the ordinary processes of FIG. 4. Since the reception process has to be executed with higher priority, the reception process is handled as an interrupt. Referring to FIG. 5, an interrupt is started by the control section 42 when an incoming call occurred (step S28). In the interrupt, the reception process is executed (step S29). When the reception process is ended, the interrupt is ended (step S30).

FIG. 6 is a schematic diagram explaining the dial lock setting/releasing operations of the mobile terminal of the first embodiment.

Input of a specific secret number (factor 4) causes a state transition 3 from the dial locked state 1 to the dial unlocked state 2.

On the other hand, state transition from the dial unlocked state 2 to the dial locked state 1 is caused by various factors. The dial lock setting operation (factor 6), interface connection detection (factor 8), charging state detection (factor 10) and folded state detection (factor 12) shown in FIG. 6 cause state transitions 5, 7, 9 and 11 from the dial unlocked state 2 to the dial locked state 1.

As shown in FIG. 6, the mobile terminal in the dial locked state 1 turns into the dial unlocked state 2 when the specific secret number is inputted from the control panel 52. It is possible to let the mobile terminal in the dial unlocked state 2 return to the dial locked state 1 by the dial lock setting operation (factor 6) which is performed by the user in the menu processing of the step S23 of FIG. 4.

The condition (factors) for the state transition from the dial unlocked state 2 to the dial locked state 1 can be set in various ways. For example, only one selected from the factors 8 (detection of connection of an external device to the interface), 10 (detection of the charging state of the mobile terminal) and 12 (detection of the folded state of the mobile terminal) can be set as the condition for the state transition from the dial unlocked state 2 to the dial locked state 1. It is also possible to set one or more factors selected from the factors 6 (dial lock setting operation similar to the prior art), 8, 10 and 12 as the condition for the state transition (2→1). Therefore, there is a case where only the charging state detection (factor 10) is selected as the condition for the state transition (2→1). There is also a case where the charging state detection (factor 10) and the folded state detection (factor 12) are selected as the state transition condition. In the latter case, the state transition (2→1) occurs when the charging state or the folded state of the mobile terminal is detected.

To sum up, the conditions for the state transitions (1→2, 2→1) can be set as follows:

(Ex. 1)

| | |
|---|---|
| (1→2) | secret number input (factor 4) |
| (2→1) | dial lock setting operation (factor 6) |

(Ex. 2)

| | |
|---|---|
| (1→2) | secret number input (factor 4) |
| (2→1) | interface connection detection (factor 8) |

(Ex. 3)

| | |
|---|---|
| (1→2) | secret number input (factor 4) |
| (2→1) | charging state detection (factor 10) |

(Ex. 4)

| | |
|---|---|
| (1→2) | secret number input (factor 4) |
| (2→1) | folded state detection (factor 12) |

(Ex. 5)

| | |
|---|---|
| (1→2) | secret number input (factor 4) |
| (2→1) | dial lock setting operation (factor 6) or |
| | interface connection detection (factor 8) |

(Ex. 6)

| | |
|---|---|
| (1→2) | secret number input (factor 4) |
| (2→1) | dial lock setting operation (factor 6) or |
| | charging state detection (factor 10) |

(Ex. 7)

| | |
|---|---|
| (1→2) | secret number input (factor 4) |
| (2→1) | dial lock setting operation (factor 6) or |
| | folded state detection (factor 12) |

(Ex. 8)

| | |
|---|---|
| (1→2) | secret number input (factor 4) |
| (2→1) | interface connection detection (factor 8) or |
| | charging state detection (factor 10) |

(Ex. 9)

| | |
|---|---|
| (1→2) | secret number input (factor 4) |
| (2→1) | interface connection detection (factor 8) or |
| | folded state detection (factor 12) |

(Ex. 10)

| | |
|---|---|
| (1→2) | secret number input (factor 4) |
| (2→1) | charging state detection (factor 10) or |
| | folded state detection (factor 12) |

(Ex. 11)

| | |
|---|---|
| (1→2) | secret number input (factor 4) |
| (2→1) | dial lock setting operation (factor 6) or |
| | interface connection detection (factor 8) or |
| | charging state detection (factor 10) |

(Ex. 12)

| | |
|---|---|
| (1→2) | secret number input (factor 4) |
| (2→1) | dial lock setting operation (factor 6) or |
| | interface connection detection (factor 8) or |
| | folded state detection (factor 12) |

(Ex. 13)

| | |
|---|---|
| (1→2) | secret number input (factor 4) |
| (2→1) | dial lock setting operation (factor 6) or |
| | charging state detection (factor 10) or |
| | folded state detection (factor 12) |

(Ex. 14)

| | |
|---|---|
| (1→2) | secret number input (factor 4) |
| (2→1) | interface connection detection (factor 8) or |
| | charging state detection (factor 10) or |
| | folded state detection (factor 12) |

(Ex. 15)

| | |
|---|---|
| (1→2) | secret number input (factor 4) |
| (2→1) | dial lock setting operation (factor 6) or |
| | interface connection detection (factor 8) or |
| | charging state detection (factor 10) or |
| | folded state detection (factor 12) |

The first four examples (Ex.1˜Ex.4) are examples in which a factor is selected out of the factors 6, 8, 10 and 12 as the condition for the state transition (2→1). The next six examples (Ex.5˜Ex.10) are examples in which two factors are selected as the condition for the state transition (2→1). The next four examples (Ex.11˜Ex.14) are examples in which three factors are selected as the condition for the state transition (2→1). In the last example (Ex.15), all the four factors 6, 8, 10 and 12 are selected.

A condition to be used for the state transition from the dial unlocked state 2 to the dial locked state 1 is selected by the user, and the selected condition is set to the control section 42. If we define “flags” corresponding to the factors 6 (dial lock setting operation), 8 (interface connection detection), 10 (charging state detection) and 12 (folded state detection) as F1, F2, F3 and F4 respectively, flags corresponding to the factors selected by the user are set to “1” and the condition (dial lock mode) for the state transition (2→1) is determined by the combination of the flags. For example, flags (F1, F2, F3, F4)=(1, 1, 0, 0) mean that the condition of Ex.5 has been selected. The dial lock mode (flags) is set by the user in the menu processing (step S23 of FIG. 4).

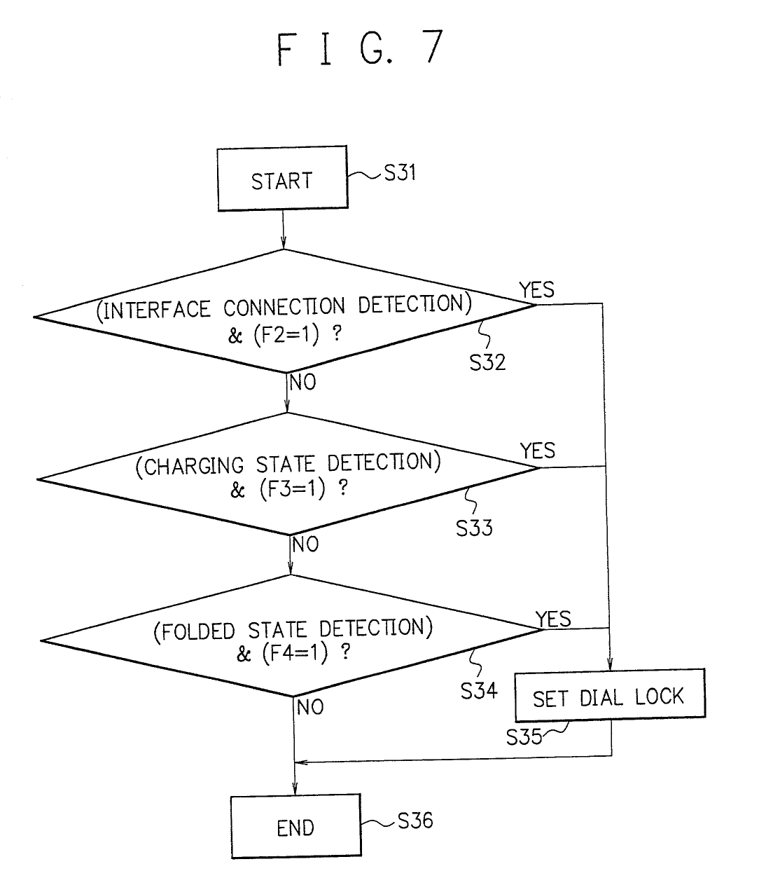

FIG. 7 is a flow chart explaining an example of a judgment process in which the control section 42 judges whether the dial lock should be set or not. Incidentally, it is assumed in the following explanation that the factors 8 (interface connection detection), 10 (charging state detection) and 12 (folded state detection) have been selected by the user as the condition for the state transition (2→1) and the flags (F1, F2, F3, F4) have been set to (0, 1, 1, 1).

The charge/power control section 46 outputs an interrupt signal to the control section 42 when it detected that the mobile terminal is being charged. The interface 47 outputs an interrupt signal to the control section 42 when it detected that an external device is connected thereto. In the same way, the control panel/switch input section 45 outputs an interrupt signal to the control section 42 when it detected that the mobile terminal is folded. The control section 42 starts an interrupt when an interrupt signal is supplied from the charge/power control section 46, the interface 47 or the control panel/switch input section 45 (step S31).

If an interrupt signal is supplied from the interface 47, the control section 42 refers to the flag F2 of the dial lock mode which has been set in the menu processing of the step S23 of FIG. 4 and checks whether or not the flag F2 (corresponding to the interface connection detection (factor 8)) is 1 (step S32). If the flag F2 has been set to 1 (“YES” in the step S32), the process proceeds to a step S35. If no interrupt signal is supplied from the interface 47 or the flag F2 has been set to 0 (“NO” in the step S32), the process proceeds to the next step S33.

If an interrupt signal is supplied from the charge/power control section 46, the control section 42 refers to the flag F3 of the dial lock mode and checks whether or not the flag F3 (corresponding to the charging state detection (factor 10)) has been set to 1 (step S33). If the flag F3 has been set to 1 (“YES” in the step S33), the process proceeds to the step S35. If no interrupt signal is supplied from the charge/power control section 46 or the flag F3 has been set to 0 (“NO” in the step S33), the process proceeds to the next step S34.

If an interrupt signal is supplied from the control panel/switch input section 45, the control section 42 refers to the flag F4 of the dial lock mode and checks whether or not the flag F4 (corresponding to the folded state detection (factor 12)) has been set to 1 (step S34). If the flag F4 has been set to 1 (“YES” in the step S34), the process proceeds to the step S35. If no interrupt signal is supplied from the control panel/switch input section 45 or the flag F4 has been set to 0 (“NO” in the step S34), the process is ended (step S36).

In the step S35 (“YES” in the step S32, S33 or S34), the control section 42 sets the dial lock. Therefore, in the example of FIG. 7, the control section 42 changes the state of the mobile terminal from the dial unlocked state 2 to dial locked state 1 if “YES” in the step S32 (an external device is connected to the interface 47 and the flag F2 of the dial lock mode is 1) or “YES” in the step S33 (the mobile terminal is being charged and the flag F3 is 1) or “YES” in the step S34 (the mobile terminal is folded and the flag F4 is 1). After the dial lock setting process of the step S35, the interrupt is ended (step S36).

As described above, by the mobile terminal in accordance with the first embodiment of the present invention, the user is allowed to use the dial lock function more easily in comparison with the conventional mobile terminals. For example, the dial lock is automatically set when the mobile terminal is connected to an external device or when the mobile terminal is being charged. Therefore, even if the user left the mobile terminal in such statuses without performing the dial lock setting operation, illegal use by a third party can be prevented easily.

A user of a foldable mobile terminal (such as a foldable portable cellular phone) generally folds it when a call is over. The user of the mobile terminal of the first embodiment is allowed to set the dial lock very easily with an easy operation of folding the mobile terminal.

Embodiment 2

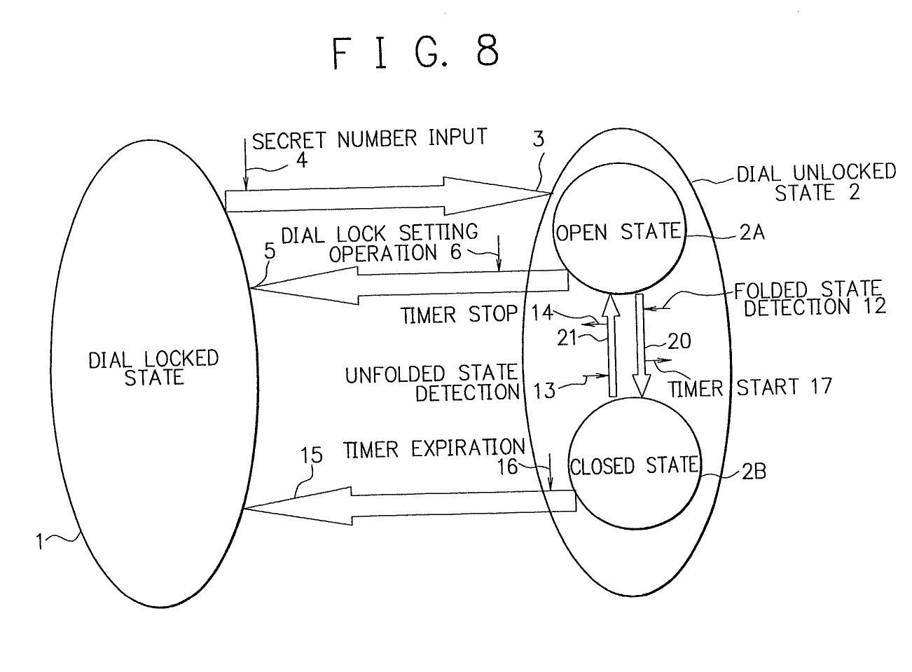

FIG. 8 is a schematic diagram explaining dial lock setting/releasing operations of a mobile terminal in accordance with a second embodiment of the present invention.

In FIG. 8, the reference numerals “1” and “2” denote the dial locked state and the dial unlocked state respectively in the same way as the first embodiment. The reference numeral “2A” denotes a state in the dial unlocked state 2 in which the mobile terminal is regarded to be unfolded (hereafter, referred to as “open state”). The reference numeral “2B” denotes a state in the dial unlocked state 2 in which the mobile terminal is regarded to be folded (hereafter, referred to as “closed state”). Therefore, the dial unlocked state 2 includes the open state 2A and the closed state 2B. Although the dial locked state 1 also includes an open state and a closed state, explanation thereof will be omitted for the sake of simplicity. Thick arrows “3”, “5”, “15”, “20” and “21” denote state transitions, in which “3” denotes a state transition from the dial locked state 1 to the open state 2A, “5” denotes a state transition from the open state 2A to the dial locked state 1, “15” denotes a state transition from the closed state 2B to the dial locked state 1, “20” denotes a state transition from the open state 2A to the closed state 2B, and “21” denotes a state transition from the closed state 2B to the open state 2A. Thin arrows “4”, “6”, “12”, “13” and “16” pointing toward the thick arrows (state transitions) denote factors for the state transitions 3, 5, 20, 21 and 15. The thin arrow “14” exiting from the thick arrow (state transition) 21 denotes an event which occurs when the state transitions 21 occurs. The thin arrow “17” exiting from the thick arrow (state transition) 20 denotes an event which occurs when the state transition 20 occurs.

In the dial locked state 1, if a specific secret number is inputted (factor 4), the state of the mobile terminal turns into the open state 2A of the dial unlocked state 2 (state transition 3). On the other hand, in the open state 2A, if a dial lock setting operation is performed (factor 6), the state of the mobile terminal returns to the dial locked state 1 (state transition 5).

In the open state 2A, if the folded state of the mobile terminal is detected (factor 12), a dial lock setting timer is started (event 17) and the state of the mobile terminal turns into the closed state 2B (state transition 20). In the closed state 2B, if the unfolded state of the mobile terminal is detected before the dial lock setting timer counts a preset time-out period (factor 13), the dial lock setting timer is stopped (event 14) and the state of the mobile terminal returns to the open state 2A (state transition 21). If the timer counted the preset time-out period (factor 16) in the closed state 2B, the state of the mobile terminal turns into the dial locked state 1 (state transition 15).

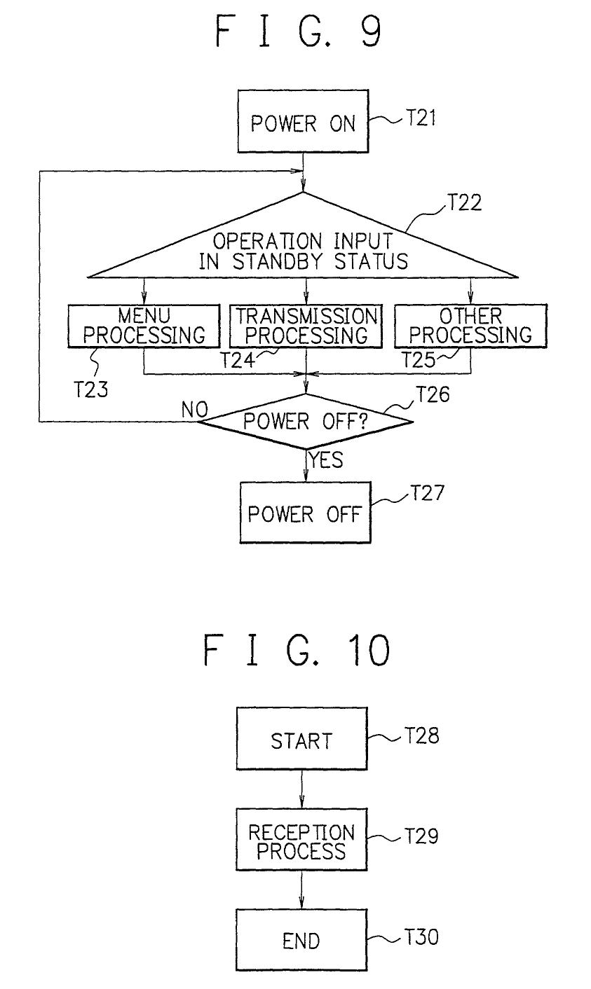

FIG. 9 is a flow chart explaining the operation of the control section 42 of the mobile terminal of the second embodiment. When the power of the mobile terminal is turned on (step T21), the mobile terminal in a standby status waits for an operation input by the user (step T22). Depending on the type of the operation input, the process of FIG. 9 proceeds to a step T23 (menu processing), a step T24 (transmission processing) or a step T25 (other processing). The menu processing of the step T23 is executed when a menu key of the control panel 52 is pushed by the user. The menu processing of the step T23 includes the dial lock setting operation 6 (a dial lock setting process according to the dial lock setting operation 6 by the user) and a dial lock mode setting process which will be explained later. The transmission processing of the step T24 is executed when transmission operation (key entry for call origination) is done by the user. The “other processing” of the step T25 includes the dial lock releasing (state transition 3 of FIG. 8) which is executed when the specific secret number is inputted. The control section 42 repeats the above process until the power of the mobile terminal is turned off (“YES” in step T26).

FIG. 10 is a flow chart explaining a reception process which is executed as one of interrupts in the mobile terminal of the second embodiment. An interrupt is started by the control section 42 when an incoming call occurred (step T28). In the interrupt, the reception process is executed (step T29). When the reception process is ended, the interrupt is ended (step T30).

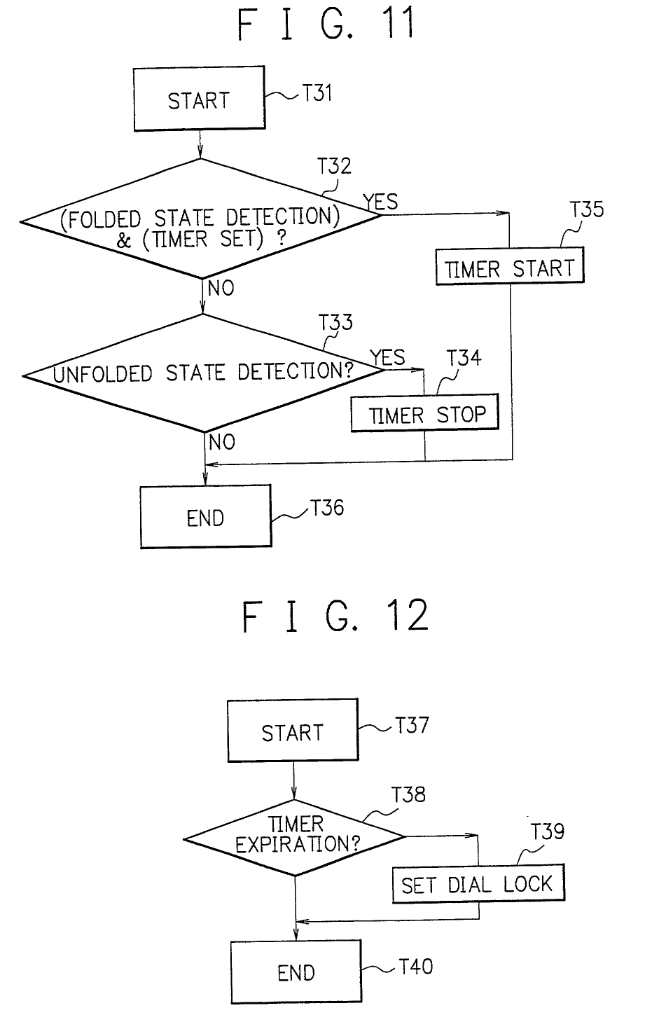

FIG. 11 is a flow chart explaining an interrupt which is executed in the mobile terminal of the second embodiment when the folded state or the unfolded state is detected. The interrupt of FIG. 11 is started when the reed switch 55 detected the folded state or the unfolded state of the mobile terminal (step T31). If the folded state is detected by the reed switch 55 and a time-out period (which will be explained later) has been set to the dial lock setting timer (“YES” in step T32), the dial lock setting timer is started (step T35). If the dial lock setting timer has been set OFF, a judgment of a step T33 is made regardless of whether or not the mobile terminal is in the unfolded state. In the step T33, it is judged whether or not the unfolded state is detected by the reed switch 55. If the unfolded state is detected (“YES” in step T33), the dial lock setting timer is stopped (step T34). If the unfolded state is not detected (“NO” in step T33), the process of FIG. 11 is ended (step T36).

FIG. 12 is a flow chart explaining a timer interrupt process which is executed in the mobile terminal of the second embodiment. The timer interrupt process of FIG. 12 is started repeatedly (periodically, for example) while the dial lock setting timer which has been started in the step T35 of FIG. 12 is counting (step T37). In a step T38, it is judged whether or not the dial lock setting timer has counted to the preset time-out period (timer expiration). If the dial lock setting timer has expired (“YES” in step T38), the control section 42 sets the dial lock (step T39). If the dial lock setting timer has not expired (“NO” in step T38), the timer interrupt process of FIG. 12 is ended without setting the dial lock (step T40).

In the following, the operation of the mobile terminal of in accordance with the second embodiment of the present invention will be explained in detail.

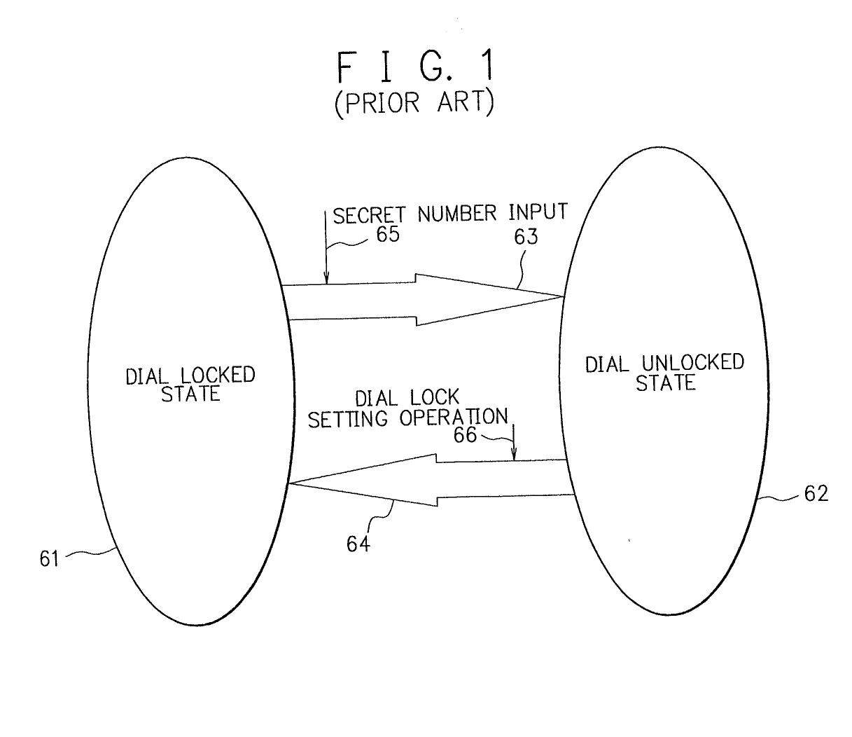

Referring to FIG. 8, the mobile terminal in the dial locked state 1 turns into the dial unlocked state 2 only when a specific secret number is inputted from the control panel 52 (factor 4). The mobile terminal in the dial unlocked state 2 can be turned into the dial locked state 1 by performing the dial lock setting operation (factor 6) in the menu processing of the step T23 of FIG. 9. The dial lock setting operation (factor 6) is the same as the dial lock setting operation 66 of the conventional mobile terminal (see FIG. 1).

In the mobile terminal of the second embodiment, “automatic dial lock mode” is set in the menu processing (step T23), in which the user previously selects and sets a time-out period of the dial lock setting timer. In an automatic dial lock mode setting screen which is displayed in the menu processing (step T23), the user makes a selection from “0 minute”, “1 minute”, “2 minutes”, “3 minutes”, “4 minutes”, “5 minutes” and “OFF”.

In the case where the automatic dial lock mode has been set to “0 minute”, an interrupt signal is inputted to the control section 42 when the folded state of the mobile terminal is detected by the reed switch 55 and the control panel/switch input section 45 (factor 12). In this case, the interrupt of FIG. 11 is activated (step T31) and the dial lock setting timer is started (step T35) as the result of the judgment step T32, however, the time-out expires instantly (“YES” in the step T38) and the dial lock is set in no time by the control section 42 (step T39).

In the case where the automatic dial lock mode has been set to “1 minute”, “2 minutes”, “3 minutes”, “4 minutes” or “5 minutes”, the interrupt of FIG. 11 is activated when the mobile terminal is folded (“YES” in the step T32) and the dial lock setting timer is started so as to count the time-out period (1 minute˜5 minutes) (step T35). If the folded mobile terminal is unfolded while the dial lock setting timer is still counting (“YES” in the step T33), the dial lock setting timer is stopped (step T34). When the unfolded mobile terminal is folded again (“YES” in the step T32), the dial lock setting timer is started again so as to count the time-out period (step T35). If the folded state continued for the time-out period, the dial lock setting timer expires (“YES” in the step T38) and thereby the dial lock is set by the control section 42 (step T39).

In the case where the automatic dial lock mode has been set “OFF” , the dial lock setting timer is not started as the result of the judgment step T32, therefore, the timer interrupt process of FIG. 12 is not executed. In this case, the automatic dial lock setting is not executed, and thus the user have to perform the dial lock setting operation (factor 6) in order to set the dial lock, similarly to the cases of conventional mobile terminals.

As described above, in the mobile terminal in accordance with the second embodiment of the present invention, the dial lock can automatically be set according to the detection of the folded state of the mobile terminal. A user of a foldable mobile terminal such as a foldable portable cellular phone generally folds it (or folds a flipper of it) from habit when a call or an operation input is over. The mobile terminal of the second embodiment prevents itself from being left in the dial unlocked state 2 by use of the habit of the user.

Further, various time-out period can be set to the dial lock setting timer and thereby an appropriate time difference can be provided between the folding of the mobile terminal (or folding of a flipper) and the automatic dial lock setting. Therefore, unnecessary automatic dial lock setting during frequent use of the mobile terminal (for conversation, sending e-mails, etc.) can be avoided.

While a mobile terminal whose dial lock is automatically set when each call is over has been devised (aforementioned first prior art: Japanese Patent Application Laid-Open No.HEI10-257170) in order to set the dial lock without fail, such automatic dial lock setting (requiring frequent input of the secret number for releasing) becomes troublesome and inconvenient when the user makes calls successively. Such a problem is resolved by the mobile terminal of the second embodiment.

Incidentally, while the expression “dial lock” has been used in the above embodiments, various types of “dial locks” are employed in mobile terminals. For example, in a dial lock function employed in many portable cellular phones, the user is required to input a secret number when the power is turned on, and operation of the mobile terminal by the user is totally prohibited if a secret number inputted by the user is incorrect. Therefore, the expression “dial lock” used in the above embodiments is intended to include such dial lock (operation lock). In the following claims, an expression “operation lock” is used in order to include the wide meaning of the “dial lock”.

As set forth hereinabove, by the mobile terminals and the operation lock (dial lock) setting methods in accordance with the present invention, the user is allowed to use the dial lock function or operation lock function more easily and thereby the prevention of third party's illegal use is attained more efficiently.

While the term “folding” has been used above, the present invention is not limited to mobile terminal of the folding type. The present invention can be applied to mobile terminal of various types such as a flipper type mobile terminal (whose flipper is opened when the mobile terminal is used), a mobile terminal whose case is slid when the mobile terminal is used, etc. as long as the used/unused states can be detected by use of a sensor. Therefore, the expression “folded state” in the following claims means the unused state of the mobile terminal that can be detected by use of a sensor. The sensor is not limited to a magnetic sensor such as the reed switch 55. Mechanical sensors, optical sensors, etc. can also be employed.

In the mobile terminals of the above embodiments, it is also possible to omit the dial lock setting by means of the dial lock setting operation by the user (factor 6). In the second embodiment, the dial lock setting timer can also be omitted (dial lock is set when the mobile terminal is folded). The primary effects of the second embodiment (setting of the dial lock without fail by use of the habit of the user, avoidance of too frequent dial lock setting) can be obtained even if the dial lock setting timer is omitted.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if a folded state of the mobile terminal is detected by the mobile terminal.

2. A mobile terminal as claimed in claim 1, wherein:
the state of the mobile terminal is turned from the operation unlocked state to the operation locked state if a lock setting operation is performed by a user.

3. A mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if external device connection to the mobile terminal is detected by the mobile terminal.

4. A mobile terminal as claimed in claim 3, wherein:
the state of the mobile terminal is turned from the operation unlocked state to the operation locked state if a lock setting operation is performed by a user.

5. A mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if a battery charging state of the mobile terminal is detected by the mobile terminal.

6. A mobile terminal as claimed in claim 5, wherein:
the state of the mobile terminal is turned from the operation unlocked state to the operation locked state if a lock setting operation is performed by a user.

7. A mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if at least one of a folded state of the mobile terminal and external device connection to the mobile terminal is detected by the mobile terminal.

8. A mobile terminal as claimed in claim 7, wherein:
the state of the mobile terminal is turned from the operation unlocked state to the operation locked state if a lock setting operation is performed by a user.

9. A mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if at least one of a folded state and a battery charging state of the mobile terminal is detected by the mobile terminal.

10. A mobile terminal as claimed in claim 9, wherein:
the state of the mobile terminal is turned from the operation unlocked state to the operation locked state if a lock setting operation is performed by a user.

11. A mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if at least one of external device connection to the mobile terminal and a battery charging state of the mobile terminal is detected by the mobile terminal.

12. A mobile terminal as claimed in claim 11, wherein:
the state of the mobile terminal is turned from the operation unlocked state to the operation locked state if a lock setting operation is performed by a user.

13. A mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if at least one of a folded state of the mobile terminal, external device connection to the mobile terminal, and a battery charging state of the mobile terminal is detected by the mobile terminal.

14. A mobile terminal as claimed in claim 13, wherein:
the state of the mobile terminal is turned from the operation unlocked state to the operation locked state if a lock setting operation is performed by a user.

15. A mobile terminal having an operation lock function, comprising:
a folded/unfolded state detection means for detecting whether the mobile terminal is in a folded state or in an unfolded state; and
an operation lock setting means for setting the operation lock of the mobile terminal according to detection of a state transition from the unfolded state to the folded state by the folded/unfolded state detection means.

16. A mobile terminal as claimed in claim 15, further comprising an operation lock setting timer which is started when the state transition from the unfolded state to the folded state is detected by the folded/unfolded state detection means, wherein:
the operation lock setting timer is stopped when a state transition from the folded state to the unfolded state is detected by the folded/unfolded state detection means, and
the operation lock setting means sets the operation lock if the operation lock setting timer counted a preset time-out period.

17. A mobile terminal as claimed in claim 16, further comprising a timer setting means for letting a user set on/off and the time-out period of the operation lock setting timer.

18. An operation lock setting method for a mobile terminal having an operation lock function, wherein:
the state of the mobile terminal is turned from an operation locked state to an operation unlocked state if a specific secret number is inputted to the mobile terminal, and
the state of the mobile terminal is turned from the operation unlocked state to the operation locked state if at least one of a folded state of the mobile terminal, external device connection to the mobile terminal, and a battery charging state of the mobile terminal is detected by the mobile terminal.

19. An operation lock setting method as claimed in claim 18, wherein:
the state of the mobile terminal is turned from the operation unlocked state to the operation locked state if a lock setting operation is performed by a user.

20. An operation lock setting method for a mobile terminal having an operation lock function, comprising the steps of:
a folded/unfolded state detection step in which whether the mobile terminal is in a folded state or in an unfolded state is detected; and
an operation lock setting step in which the operation lock of the mobile terminal is set according to detection of a state transition from the unfolded state to the folded state by the folded/unfolded state detection step.

21. An operation lock setting method as claimed in claim 20, wherein the operation lock setting step includes:
an operation lock setting timer starting step in which an operation lock setting timer is started when the state transition from the unfolded state to the folded state is detected by the folded/unfolded state detection step;
an operation lock setting timer stopping step in which the operation lock setting timer is stopped when a state transition from the folded state to the unfolded state is detected by the folded/unfolded state detection step; and
a time-out step in which the operation lock is set if the operation lock setting timer counted a preset time-out period.

22. An operation lock setting method as claimed in claim 21, further comprising a timer setting step in which a user sets on/off and the time-out period of the operation lock setting timer.
